(19) United States
(12) Patent Application Publication
(10) Pub. No.: US 2016/0146229 A1
(43) Pub. Date: May 26, 2016

(54) SYSTEM AND METHOD FOR ROTORS

(71) Applicant: Energy Recovery, Inc., San Leandro, CA (US)

(72) Inventors: Jeremy Grant Martin, Oakland, CA (US); James Lee Arluck, Hayward, CA (US); Alexander Miner, Oakland, CA (US)

(21) Appl. No.: 14/947,013

(22) Filed: Nov. 20, 2015

Related U.S. Application Data
(60) Provisional application No. 62/084,700, filed on Nov. 26, 2014.

(51) Int. Cl. F15B 15/06

(52) U.S. Cl. CPC F15B 15/06

(57) ABSTRACT

A system includes a rotary isobaric pressure exchanger (IPX). The rotary IPX includes a sleeve. The rotary IPX also includes a rotor having a first longitudinal length in an axial direction disposed within the sleeve in a concentric arrangement. The rotor includes at least one groove disposed along the first longitudinal length. The at least one groove extends in a circumferential direction about the rotor.

### CROSS-REFERENCE TO RELATED APPLICATIONS

This application is a non-provisional of U.S. Provisional Patent Application No. 62/084,700, entitled “SYSTEM AND METHOD FOR ROTORS”, filed Nov. 26, 2014, which is herein incorporated by reference in its entirety.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

The subject matter disclosed herein relates to rotating equipment, and, more particularly, to systems and methods for rotors of an isobaric pressure exchanger (IPX).

Rotating equipment, such as IPXs, may handle a variety of fluids. Some of these fluids may be more viscous than other fluids, which may affect the operation of the rotating equipment. In certain circumstances, handling highly viscous fluids may reduce the performance of the rotating equipment, such as by reducing the speed of the rotating equipment, thereby increasing unwanted mixing of process fluids, or causing the rotating equipment to stop rotating. Thus, the rotating equipment may be modified to be used with viscous fluids. Unfortunately, existing techniques for modifying the rotating equipment to be used with viscous fluids may cause other undesirable effects, such as increasing hydraulic losses, which may increase the cost to operate the rotating equipment and/or decrease the efficiency of the rotating equipment.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is an exploded perspective view of an embodiment of a rotary isobaric pressure exchanger (IPX);

FIG. 2 is an exploded perspective view of an embodiment of a rotary IPX in a first operating position;

FIG. 3 is an exploded perspective view of an embodiment of a rotary IPX in a second operating position;

FIG. 4 is an exploded perspective view of an embodiment of a rotary IPX in a third operating position;

FIG. 5 is an exploded perspective view of an embodiment of a rotary IPX in a fourth operating position;

FIG. 6 is a radial cross-sectional view of an embodiment of a rotor and sleeve of a rotary IPX;

FIG. 7 is an axial cross-sectional view of an embodiment of the rotor and the sleeve of the rotary IPX across a groove of the rotor, taken along line 7-7 of FIG. 6;

FIG. 8 is an axial cross-sectional view of an embodiment of the rotor and the sleeve of the rotary IPX across an end of the rotor, taken along line 8-8 of FIG. 6;

FIG. 9 is a flowchart of a method that may be used to modify a rotor of an IPX to be used with viscous fluids;

FIG. 10 is a radial cross-sectional view of an embodiment of a rotor and sleeve of a rotary IPX (e.g., having an asymmetrical groove); and

FIG. 11 is a schematic diagram of an embodiment of a frac system with a hydraulic energy transfer system.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As discussed in detail below, the disclosed embodiments relate generally to rotating equipment, and particularly to an isobaric pressure exchanger (IPX). For example, the IPX may handle a variety of fluids, some of which may be more viscous than others. Examples of viscous fluids include, but are not limited to, water-based amine solutions (e.g., an alkylamine or amine) or frac fluids (e.g., including water, chemicals, and proppant). The IPX may include chambers wherein the pressures of two volumes of a liquid may equalize, as described in detail below. In some embodiments, the pressures of the two volumes of liquid may not completely equalize. Thus, the IPX may not only operate isobarically, but also substantially isobarically (e.g., wherein the pressures equalize within approximately +/−1, 2, 3, 4, 5, 6, 7, 8, 9, or 10 percent of each other). In certain embodiments, a first pressure of a first fluid may be greater than a second pressure of a second fluid. For example, the first pressure may be between approximately 6,000 kPa to 8,000 kPa, 6,500 kPa to 7,500 kPa, or 6,750 kPa to 7,250 kPa greater than the second pressure. Thus, the IPX may be used to transfer pressure from the first fluid to the second fluid.

In certain situations, it may be desirable to use the IPX with viscous fluids. However, use of IPXs configured for less viscous fluids, such as water, with viscous fluids may cause undesirable operation of the IPX. For example, the speed of such low-viscosity IPXs may be reduced or even stopped when used with viscous fluids. In addition, the first and second fluids handled by the low-viscosity IPX may mix together more than desired when one or both of the fluids is highly viscous. Thus, it may be desirable to modify certain components of the IPX, such as the rotor, to overcome the undesirable consequences associated with viscous fluids. However, certain modifications may cause other undesirable consequences, such as increased hydraulic losses. Thus, in certain embodiments, the rotor may be modified to include a groove such that desirable operation of the IPX may be maintained when using viscous fluids without increasing hydraulic losses. For example, a length of the groove may be selected to balance viscous drag losses with hydraulic losses in certain embodiments. Use of such embodiments of the rotor may provide several advantages compared to other methods of handling viscous fluids. For example, the speed of the IPX may remain above a desired threshold because of the reduced viscous drag losses associated with such embodiments. In addition, hydraulic losses associated with the IPX may be reduced because of certain features of the rotor in the disclosed embodiments. Thus, use of the disclosed embodiments may increase the efficiency of the IPX while also reducing operating costs of the IPX.

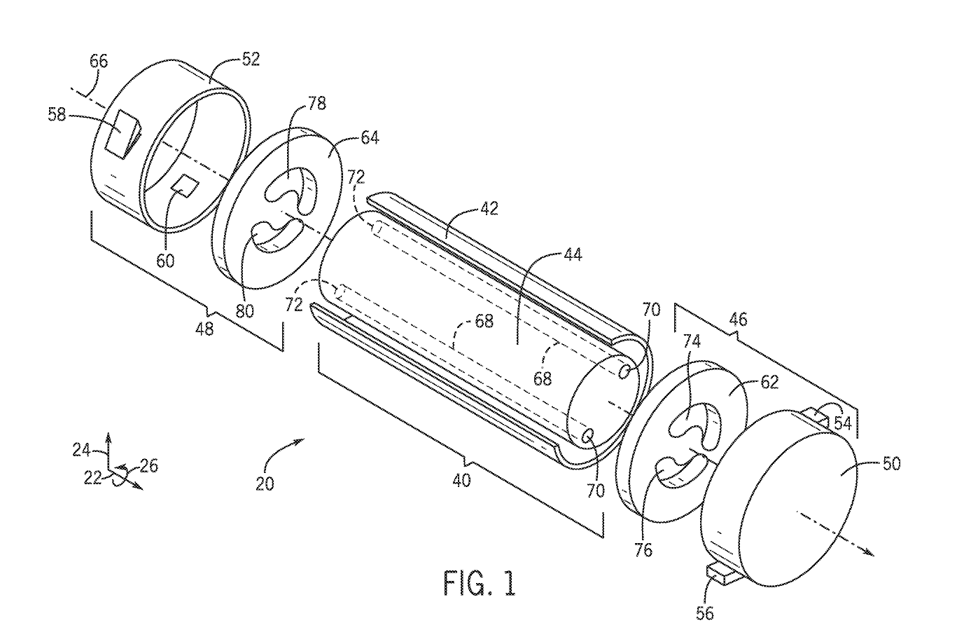

FIG. 1 is an exploded view of an embodiment of a rotary isobaric pressure exchanger (IPX) 20 that may be modified for use with viscous fluids. In the following discussion, reference may be made to an axial direction 22, a radial direction 24, and/or a circumferential direction 26 relative to a rotational axis or longitudinal axis 66 of the IPX 20. As used herein, the IPX may be generally defined as a device that transfers fluid pressure between a high-pressure inlet stream and a low-pressure inlet stream at efficiencies in excess of approximately 50%, 60%, 70%, or 80% without utilizing centrifugal technology. In this context, high pressure refers to pressures greater than the low pressure. The low-pressure inlet stream of the IPX may be pressurized and exit the IPX at high pressure (e.g., at a pressure greater than that of the low-pressure inlet stream), and the high-pressure inlet stream may be depressurized and exit the IPX at low pressure (e.g., at a pressure less than that of the high-pressure inlet stream). Additionally, the IPX may operate with the high-pressure fluid directly applying a force to pressurize the low-pressure fluid, with or without a fluid separator between the fluids. Examples of fluid separators that may be used with the IPX include, but are not limited to, pistons, bladders, diaphragms and the like. In certain embodiments, isobaric pressure exchangers may be rotary devices. Rotary isobaric pressure exchangers (IPXs) 20, such as those manufactured by Energy Recovery, Inc. of San Leandro, Calif., may not have any separate valves, since the effective valving action is accomplished internal to the device via the relative motion of a rotor with respect to end covers, as described in detail below with respect to FIGS. 1-5. Rotary IPXs may be designed to operate with internal pistons to isolate fluids and transfer pressure with little mixing of the inlet fluid streams. Reciprocating IPXs may include a piston moving back and forth in a cylinder for transferring pressure between the fluid streams. Any IPX or plurality of IPXs may be used in the disclosed embodiments, such as, but not limited to, rotary IPXs, reciprocating IPXs, or any combination thereof. While the discussion with respect to certain embodiments of the rotor advancing tool may refer to rotary IPXs, it is understood that any IPX or plurality of IPXs may be substituted for the rotary IPX in any of the disclosed embodiments. In addition, the IPX may be disposed on a skid separate from the other components of a fluid handling system, which may be desirable in situations in which the IPX is added to an existing fluid handling system.

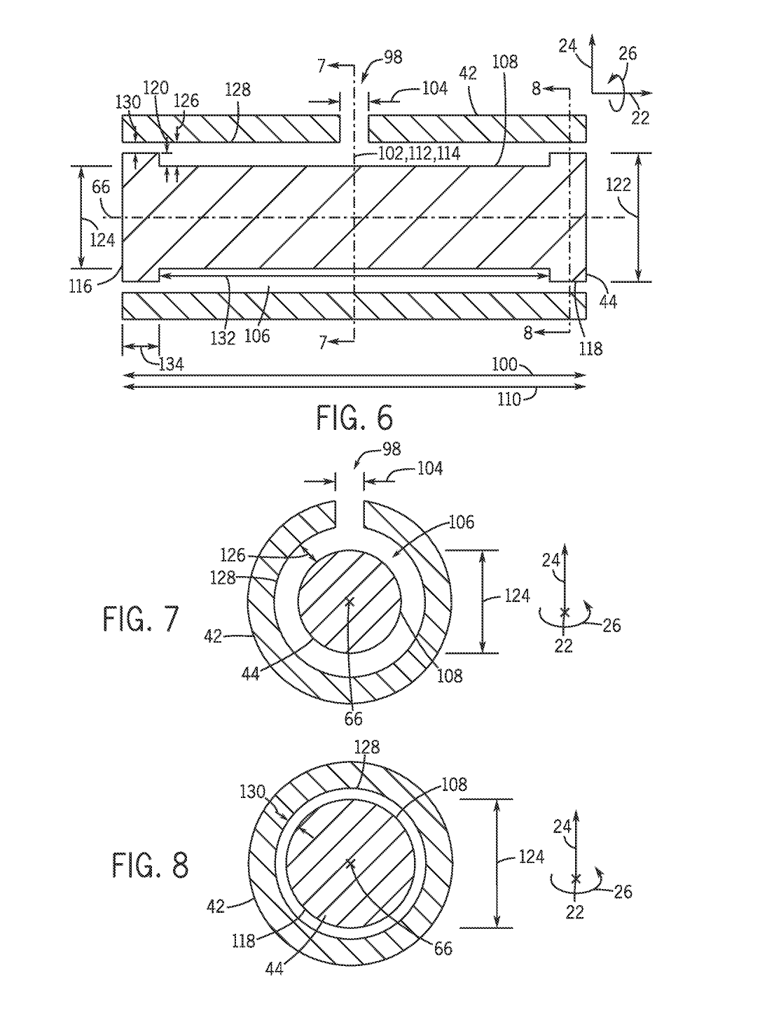

In the illustrated embodiment of FIG. 1, the rotary IPX 20 may include a generally cylindrical body portion 40 that includes a sleeve 42 and a rotor 44 (e.g., disposed within the sleeve 42 in a concentric arrangement). The rotor 44 may be modified to be used with viscous fluids, as described in detail below with respect to FIGS. 6-8. The rotary IPX 20 may also include two end structures 46 and 48 that include manifolds 50 and 52, respectively. Manifold 50 includes inlet and outlet ports 54 and 56 and manifold 52 includes inlet and outlet ports 60 and 58. For example, inlet port 54 may receive a high-pressure first fluid and the outlet port 56 may be used to route a low-pressure first fluid away from the IPX 20. Similarly, inlet port 60 may receive a low-pressure second fluid and the outlet port 58 may be used to route a high-pressure second fluid away from the IPX 20. The end structures 46 and 48 include generally flat end plates 62 and 64, respectively, disposed within the manifolds 50 and 52, respectively, and adapted for liquid sealing contact with the rotor 44. The rotor 44 may be cylindrical and disposed in the sleeve 42, and is arranged for rotation about a longitudinal axis 66 of the rotor 44. The rotor 44 may have a plurality of channels 68 extending substantially longitudinally through the rotor 44 with openings 70 and 72 at each end arranged symmetrically about the longitudinal axis 66. T he openings 70 and 72 of the rotor 44 are arranged for hydraulic communication with the end plates 62 and 64, and inlet and outlet apertures 74 and 76, and 78 and 80, in such a manner that during rotation they alternately hydraulically expose liquid at high pressure and liquid at low pressure to the respective manifolds 50 and 52. The inlet and outlet ports 54, 56, 58, and 60, of the manifolds 50 and 52 form at least one pair of ports for high-pressure liquid in one end element 46 or 48, and at least one pair of ports for low-pressure liquid in the opposite end element, 48 or 46. The end plates 62 and 64, and inlet and outlet apertures 74 and 76, and 78 and 80 are designed with perpendicular flow cross sections in the form of arcs or segments of a circle.

With respect to the IPX 20, the plant operator has control over the extent of mixing between the first and second fluids, which may be used to improve the operability of the fluid handling system. For example, varying the proportions of the first and second fluids entering the IPX 20 allows the plant operator to control the amount of fluid mixing within the fluid handling system. Three characteristics of the IPX 20 that affect mixing are: the aspect ratio of the rotor channels 68, the short duration of exposure between the first and second fluids, and the creation of a liquid barrier (e.g., an interface) between the first and second fluids within the rotor channels 68. First, the rotor channels 68 are generally long and narrow, which stabilizes the flow within the IPX 20. In addition, the first and second fluids may move through the channels 68 in a plug flow regime with very little axial mixing. Second, in certain embodiments, at a rotor speed of approximately 1200 RPM, the time of contact between the first and second fluids may be less than approximately 0.15 seconds, 0.10 seconds, or 0.05 seconds, which again limits mixing of the streams 18 and 30. Third, a small portion of the rotor channel 68 is used for the exchange of pressure between the first and second fluids. Therefore, a volume of fluid remains in the channel 68 as a barrier between the first and second fluids. All these mechanisms may limit mixing within the IPX 20.

In addition, because the IPX 20 is configured to be exposed to the first and second fluids, certain components of the IPX 20 may be made from materials compatible with the components of the first and second fluids. In addition, certain components of the IPX 20 may be configured to be physically compatible with other components of the fluid handling system. For example, the ports 54, 56, 58, and 60 may comprise flanged connectors to be compatible with other flanged connectors present in the piping of the fluid handling system. In other embodiments, the ports 54, 56, 58, and 60 may comprise threaded or other types of connectors.

FIGS. 2-5 are exploded views of an embodiment of the rotary IPX 20 illustrating the sequence of positions of a single channel 68 in the rotor 44 as the channel 68 rotates through a complete cycle, and are useful to an understanding of the rotary IPX 20. It is noted that FIGS. 2-5 are simplifications of the rotary IPX 20 showing one channel 68 and the channel 68 is shown as having a circular cross-sectional shape. In other embodiments, the rotary IPX 20 may include a plurality of channels 68 (e.g., 2 to 100) with different cross-sectional shapes. Thus, FIGS. 2-5 are simplifications for purposes of illustration, and other embodiments of the rotary IPX 20 may have configurations different from that shown in FIGS. 2-5. As described in detail below, the rotary IPX 20 facilitates a hydraulic exchange of pressure between two liquids by putting them in momentary contact within a rotating chamber. In certain embodiments, this exchange happens at a high speed that results in very high efficiency with very little mixing of the liquids.

In FIG. 2, the channel opening 70 is in hydraulic communication with aperture 76 in endplate 62 and therefore with the manifold 50 at a first rotational position of the rotor 44 and opposite channel opening 72 is in hydraulic communication with the aperture 80 in endplate 64, and thus, in hydraulic communication with manifold 52. As discussed below, the rotor 44 rotates in the clockwise direction indicated by arrow 90. As shown in FIG. 2, low-pressure second fluid 92 passes through end plate 64 and enters the channel 68, where it pushes first fluid 94 out of the channel 68 and through end plate 62, thus exiting the rotary IPX 20. The first and second fluids 92 and 94 contact one another at an interface 96 where minimal mixing of the liquids occurs because of the short duration of contact. The interface 96 is a direct contact interface because the second fluid 92 directly contacts the first fluid 94.

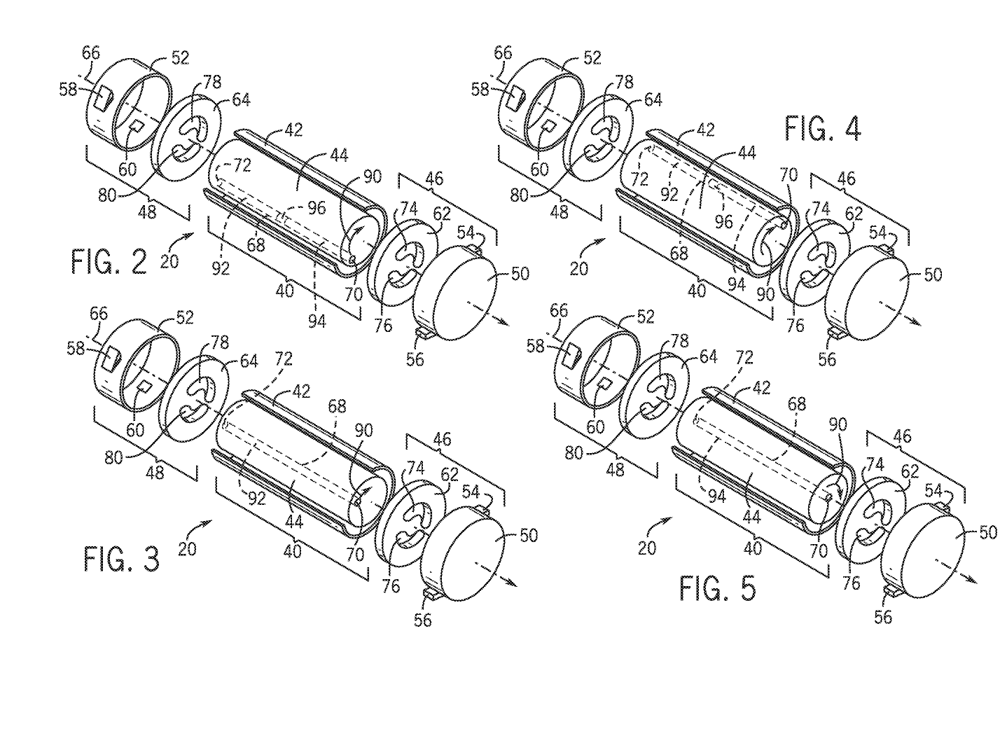

In FIG. 3, the channel 68 has rotated clockwise through an arc of approximately 90 degrees, and outlet 72 is now blocked off between apertures 78 and 80 of end plate 64, and outlet 70 of the channel 68 is located between the apertures 74 and 76 of end plate 62 and, thus, blocked off from hydraulic communication with the manifold 50 of end structure 46. Thus, the low-pressure second fluid 92 is contained within the channel 68.

In FIG. 4, the channel 68 has rotated through approximately 180 degrees of arc from the position shown in FIG. 2. Opening 72 is in hydraulic communication with aperture 78 in end plate 64 and in hydraulic communication with manifold 52, and the opening 70 of the channel 68 is in hydraulic communication with aperture 74 of end plate 62 and with manifold 50 of end structure 46. The liquid in channel 68, which was at the pressure of manifold 52 of end structure 48, transfers this pressure to end structure 46 through outlet 70 and aperture 74, and comes to the pressure of manifold 50 of end structure 46. Thus, high-pressure first fluid 94 pressurizes and displaces the second fluid 92.

In FIG. 5, the channel 68 has rotated through approximately 270 degrees of arc from the position shown in FIG. 2, and the openings 70 and 72 of channel 68 are between apertures 74 and 76 of end plate 62, and between apertures 78 and 80 of end plate 64. Thus, the high-pressure first fluid 94 is contained within the channel 68. When the channel 68 rotates through approximately 360 degrees of arc from the position shown in FIG. 2, the second fluid 92 displaces the first fluid 94, restarting the cycle.

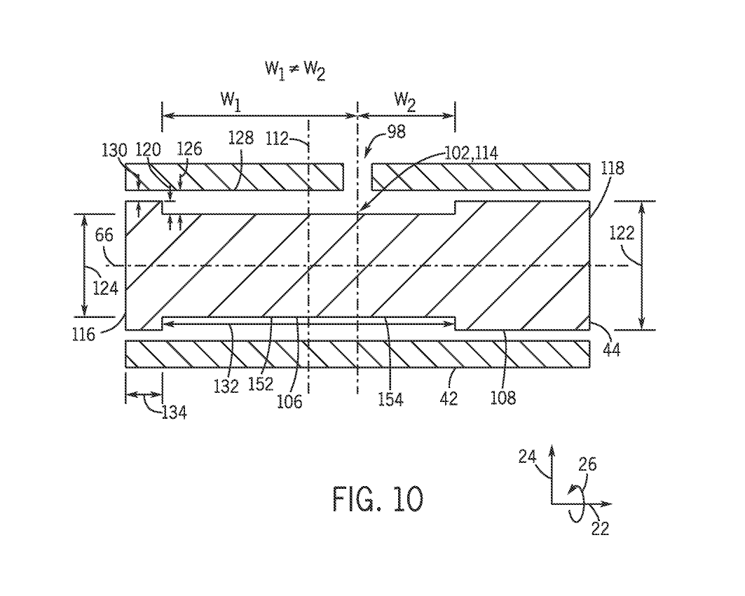

FIG. 6 is a radial cross-sectional view of an embodiment of the rotor 44 and sleeve 42 of the rotary IPX 20 configured for use with viscous fluids (e.g., amines, frac fluid, etc.). As shown in FIG. 6, the sleeve 42 includes an opening 98 (e.g., hole) disposed along a longitudinal length 100 of the sleeve 42, which may be disposed near an axial midpoint 102 of the sleeve 42. The opening 98 may have an opening diameter 104 (or size). The diameter 104 of the opening 98 may range from approximately 0.1 to 20 percent of the longitudinal length 100 of the sleeve 42. The ratio of the diameter 104 of the opening 98 to the longitudinal length 100 of the sleeve 42 may range from 1:1000 to 1:5. The opening 98 may have a variety of cross-sectional shapes in certain embodiments including, but not limited to, circles, ovals, squares, triangles, polygons, and so forth. The opening 98 enables process fluid to enter an annular region between the sleeve 42 and the rotor 44. In the illustrated embodiment, a circumferential groove 106 is formed in an outer surface 108 of the rotor 44 along a longitudinal length 110 of the rotor 44, which may enable the fluid (e.g., process fluid or lubricating fluid) to be conveyed evenly along the circumference of the rotor 44. In certain embodiments, the groove 106 extends 360 degrees bout the rotor 44. In addition, an axial midpoint 112 of the groove 106 may be centered about an axial midpoint 114 of the rotor 44 to enable the process fluid to flow away from the axial midpoint 114 in both directions (e.g., axially) toward ends of the rotor (e.g., rotor ends 116, 118). The axial midpoint 114 of the rotor 44 may generally coincide (e.g., is centered) with the axial midpoint 102 of the sleeve 42 in certain embodiments as depicted in FIG. 6. In certain embodiments (see FIG. 10), the axial midpoint 112 of the groove 106 may off-centered from the axial midpoints 102, 114 of the sleeve 42 and the rotor 44. As the process fluid flows through the groove 106 away from the axial midpoint 112, the fluid may provide hydrodynamic bearing and cooling functions for the IPX 20.

The groove 106 shown in FIG. 6 may be defined by a variety of geometric measurements. For example, the groove 106 may be defined by a groove depth 120, which may be the difference between a diameter 122 of the rotor ends 116, 118 and a diameter 124 of the rotor 44 at the groove 106. Further, the groove 106 may be defined by a groove spacing 126, which may be the distance between an inner surface 128 of the sleeve 42 and the outer surface 108 of the groove 106. Similarly, an end spacing 130 may represent the distance between the inner surface 128 of the sleeve 42 and the outer surface 108 of the rotor ends 116, 118. Thus, the groove spacing 126 may also equal the sum of the end spacing 130 and groove depth 120. Moreover, the groove 106 may be defined by a groove length 132, which may represent a length of the groove 106 in the axial direction 22. As shown in FIG. 6, the groove 106 may not extend along the complete length 110 of the rotor 44. The rotor ends 118, 118 may be defined by a rotor or end length 134. A sum of the groove length 132 and both end lengths 134 may generally equal a total length 110 of the rotor 44. In certain embodiments, the groove length 132 is at least half of the length 110 of the rotor 44. In certain embodiments, the groove length 132 may be approximately 10, 20, 30, 40, 50, 60, 70, 80, or 90 percent of the length 110 of the rotor 44, and all percentages therebetween. As described in detail below, one or more of the geometric measurements or characteristics of the rotor 44 may be modified to enable the rotor 44 to be used in IPXs 20 handling viscous fluids.

FIG. 7 is an axial cross-sectional view of an embodiment of the rotor 44 and sleeve 42 of the IPX 20 across the groove 106 of the rotor 44, taken along line 7-7 of FIG. 6. As shown in FIG. 7, the groove spacing 126 defines the annular region between the inner surface 128 of the sleeve 42 and the outer surface 108 of the groove 106. It is through this annular region that the process fluid may flow to provide both hydrodynamic bearing and cooling functions for the IPX 20. In addition, the groove 106 helps to reduce viscous drag losses, thereby helping a desired speed of the rotor 44 to be maintained. By maintaining the speed of the rotor 44 above a desired threshold, the groove 106 may help reduce mixing of process fluids that may be caused by a slowly-turning rotor 44. In other words, at low rotor speeds, the contact time between the first and second fluids handled by the IPX 20 increases, which also increases mixing of the fluids. By maintaining high rotor speeds with viscous fluids through use of the rotor 44 with groove 106 and rotor ends 116, 118, a small contact time may be maintained, which reduces mixing of the first and second fluids.

FIG. 8 is an axial cross-sectional view of an embodiment of the rotor 44 and sleeve 42 of the IPX 20 across the rotor end 118 taken along line 8-8 of FIG. 6. As shown in FIG. 8, the 122 diameter at the rotor end 118 is greater than the diameter 124 of the rotor 44 at the groove 106 shown in FIG. 7. Thus, the end spacing 130 between the inner surface 128 of the sleeve 42 and the outer surface 108 of the rotor end 118 is less than the groove spacing 126 shown in FIG. 7. The smaller end spacing 130 may help restrict the flow of the process fluid from between the sleeve 42 and the rotor ends 116, 118. Thus, the groove 106 may help provide lower viscous drag losses because of the larger groove spacing 126 while the rotor ends 116, 118 may help reduce process fluid losses because of the smaller end spacing 130. In other words, the combination of the groove 106 and the rotor ends 116, 118 may help the IPX 20 to be effectively used with viscous fluids by balancing viscous drag losses with process fluid losses. In addition, the rotor ends 116, 118 may provide a bearing function for the IPX 20.

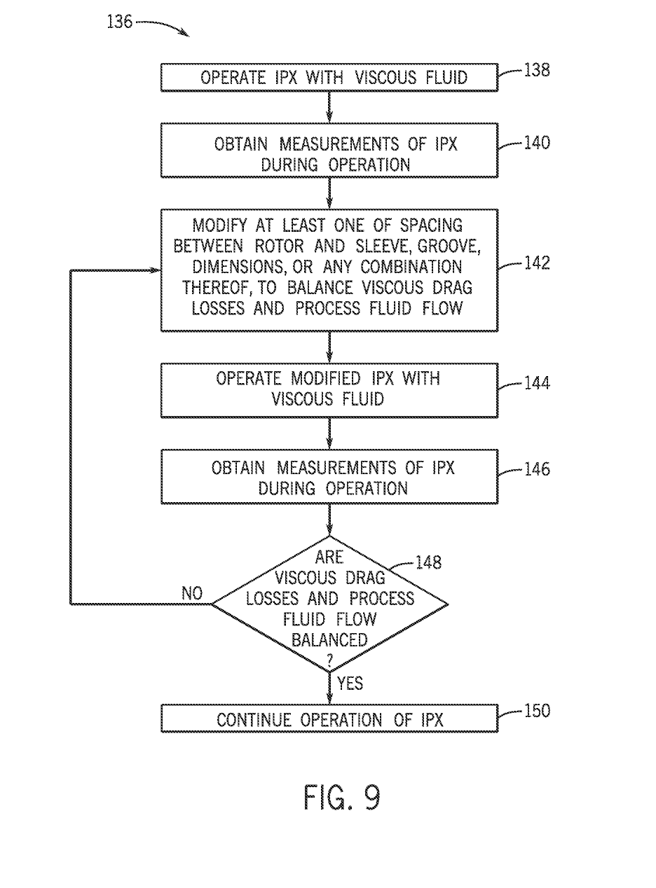

FIG. 9 is a flowchart of a method 136 that may be used to modify the rotor 44 of the IPX 20 to be used with viscous fluids, such as the rotors 44 shown in FIGS. 6-8. In a first step 138, the unmodified IPX 20 (e.g., IPX 20 with an unmodified rotor 44) may be operated with the viscous fluid. In a second step 140, various measurements of the unmodified IPX 20 handling the viscous fluid may be made. Examples of such measurements include, but are not limited to, process fluid flowrates, process fluid pressures, process fluid temperatures rotational speed of the rotor 44, sound levels, and so forth. During operation of the unmodified IPX 20, slow rotational speeds may be observed caused by high viscous drag losses. In a third step 142, at least one of the groove spacing 126, groove depth 120, groove length 132, other groove or rotor characteristics, or any combination thereof, may be modified to better balance viscous drag losses with process fluid flows or losses. In one embodiment, the rotor 44 may have a length 110 of approximately 20.3 cm, the groove length 132 may be approximately 17.8 cm, the end length 134 may be approximately 1.3 cm, the groove spacing 126 may be approximately 0.3 cm, and the end spacing 130 may be approximately 0.03 mm. Such an embodiment may reduce the viscous drag losses sufficiently to enable the rotor 44 to spin at a desired speed with the viscous fluid while still reducing the process fluid losses to a level to maintain a desired efficiency of the IPX 20. In a fourth step 144, the modified IPX 20 (e.g., IPX with modified rotor 44 that includes the groove 106 and rotor ends 116, 118) may be operated with the viscous fluid. In a fifth step 146, various measurements of the modified IPX 20 handling the viscous fluid may be made similar to those made in the second step. In a sixth step 148, the measurements obtained in the fifth step 146 may be analyzed to determine if the viscous drag losses and process fluid flows are balanced sufficiently, which may be determined based on the rotor speed and IPX efficiency. If the viscous drag losses and process fluid flows are not balanced sufficiently, then the method 136 may be repeated by modifying at least one of the geometric characteristics of step three 142. On the other hand, if the viscous drag losses and process fluid flows are balanced sufficiently, the operation of the IPX 20 with the viscous fluid may be continued in step 150.

FIG. 10 is a radial cross-sectional view of an embodiment of the rotor 44 and sleeve 42 of the rotary IPX 20 (e.g., having an asymmetrical groove 106 relative to the axial midpoints 102, 114 of the sleeve 42 and rotor 44). In general, the rotary IPX 20 shown in FIG. 10 is structurally the same as the rotary IPX 20 described in FIG. 6 except the groove 106 is asymmetric with respect to the axial midpoint 114 of the rotor 44. For example, the groove 106 extends more towards one of the rotor ends 116, 118. Thus, a length (e.g., w1, extending from the axial midpoint 114 towards the rotor end 116) of a first groove portion 152 of the groove 106 extending more towards one of the rotor ends is greater than a length (e.g., w2, extending from the axial midpoint 114 towards the opposite rotor end 118) of a second groove portion 154 of the groove 106 extending towards the opposite rotor end. In certain embodiments, the length of the first groove portion 152 may represent greater than approximately 50 percent of the total length of the groove 106. For example, the length of first groove portion 152 may range from approximately greater than 50 to 100 percent, greater than 50 to 75 percent, 60 to 75 percent, 75 to 100 percent, 85 to 100 percent, and all subranges therein, relative to the total length of the groove. In certain embodiments, a ratio of the length of the first groove portion 152 relative to the length of the second groove portion 154 may range from approximately greater than 1 to 100, 1 to 50, 1 to 25, 1 to 15, 1 to 5, 50 to 100, 50 to 75, 50 to 65, 75 to 90, 85 to 100, and all subranges therein.

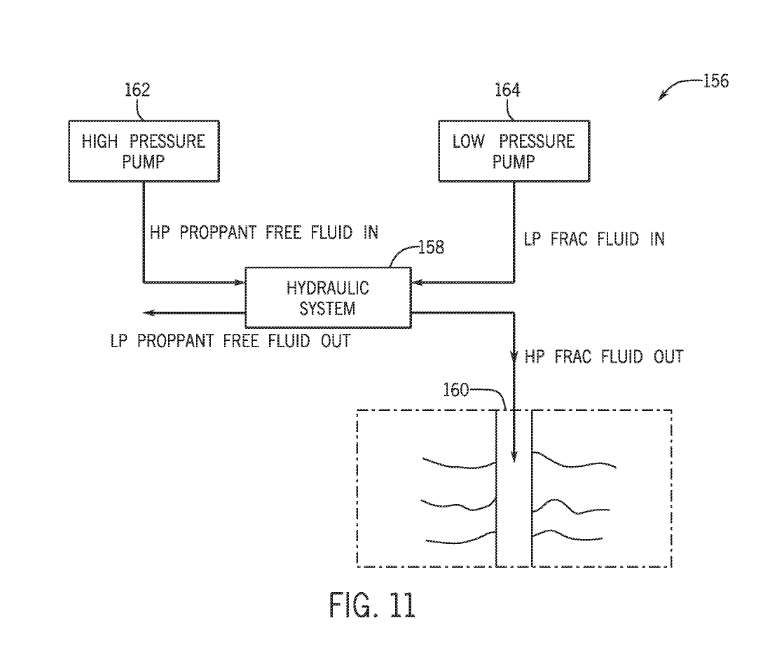

FIG. 11 is a schematic diagram of an embodiment of the frac system 156 with a hydraulic energy transfer system 158 that may utilize the above described rotary IPX 20. In operation, the frac system 156 enables well completion operations to increase the release of oil and gas in rock formations. Specifically, the frac system 156 pumps a frac fluid containing a combination of water, chemicals, and proppant (e.g., sand, ceramics, etc.) into a well 160 at high-pressures. The high-pressures of the frac fluid increases crack size and propagation through the rock formation, which releases more oil and gas, while the proppant prevents the cracks from closing once the frac fluid is depressurized. As illustrated, the frac system 156 includes a high-pressure pump 162 and a low-pressure pump 164 coupled to the hydraulic energy transfer system 158 (e.g., the rotary IPX 20 described above). In operation, the hydraulic energy transfer system 158 transfers pressures between a first fluid (e.g., proppant free fluid) pumped by the high-pressure pump 162 and a second fluid (e.g., proppant containing fluid or frac fluid) pumped by the low-pressure pump 164. In this manner, the hydraulic energy transfer system 158 blocks or limits wear on the high-pressure pump 162, while enabling the frac system 156 to pump a high-pressure frac fluid into the well 160 to release oil and gas.

In an embodiment using the IPX 20, the first fluid (e.g., high-pressure proppant free fluid) enters a first side of the hydraulic energy transfer system 160 where the first fluid contacts the second fluid (e.g., low-pressure frac fluid) entering the IPX 20 on a second side. The contact between the fluids enables the first fluid to increase the pressure of the second fluid, which drives the second fluid out of the IPX 20 and down the well 160 for fracturing operations. The first fluid similarly exits the IPX 20, but at a low-pressure after exchanging pressure with the second fluid.

In certain embodiments, the IPX 20 may be utilized in amine gas processing operations (e.g., amine gas processing systems) as disclosed in U.S. patent application Ser. No. 14/074,565, entitled “ISOBARIC PRESSURE EXCHANGER CONTROLS IN AMINE GAS PROCESSING,” and U.S. patent application Ser. No. 14/074,530, entitled “ISOBARIC PRESSURE EXCHANGER IN AMINE GAS PROCESSING,” which are incorporated by reference herein in their entirety for all purposes. While the invention may be susceptible to various modifications and

alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A system, comprising:
a rotary isobaric pressure exchanger (IPX), comprising:
a sleeve;
a rotor having a first longitudinal length in an axial direction disposed within the sleeve in a concentric arrangement, wherein the rotor comprises at least one groove disposed along the first longitudinal length, and the at least one groove extends in a circumferential direction about the rotor.

2. The system of claim 1, wherein the at least one groove extends 360 degrees in the circumferential direction about the rotor.

3. The system of claim 1, wherein the at least one groove has a groove length in the axial direction that is at least half of the first longitudinal length of the rotor.

4. The system of claim 1, wherein the rotor has a first diameter at a first end and a second end, the rotor has a second diameter at the at least one groove, and the first diameter is greater than the first diameter.

5. The system of claim 4, wherein a first distance between an inner surface of the sleeve and an outer surface of the rotor at respective lateral sides of the first and second ends is less than a second distance between the inner surface of the sleeve and the outer surface of the rotor at the at least one groove.

6. The system of claim 1, wherein a first axial midpoint of the at least one groove is centered relative to a second axial midpoint of the rotor.

7. The system of claim 1, wherein a first axial midpoint of the at least one groove is off-centered relative to a second axial midpoint of the rotor.

8. The system of claim 1, wherein the sleeve has a second longitudinal length and comprises an opening along a second longitudinal length.

9. The system of claim 8, wherein a diameter of the opening is 20 percent or less of the second longitudinal length.

10. The system of claim 8, wherein the opening is disposed at a first axial midpoint of the sleeve.

11. The system of claim 10, wherein the opening is centered relative to a second axial midpoint of the at least one groove.

12. The system of claim 10, wherein the opening is off-centered relative to a second axial midpoint of the at least one groove.

13. The system of claim 1, comprising a frac system having the rotary IPX, wherein the rotary IPX is configured to exchange pressures between a frac fluid having proppants and a proppant free fluid.

14. The system of claim 1, comprising an amine gas processing system having the rotary IPX, wherein the rotary IPX is configured to exchange pressures between amines at different pressures.

15. A rotary isobaric pressure exchanger (IPX) for transferring pressure energy from a high pressure first fluid to a low pressure second fluid, comprising:
a cylindrical rotor configured to rotate circumferentially about a rotational axis and having a first end face and a second end face disposed opposite each other with a plurality of channels extending axially therethrough between respective apertures located in the first and second end faces;
a first end cover having a first surface that interfaces with and slidingly and sealingly engages the first end face, wherein the first end cover has at least one first fluid inlet and at least one first fluid outlet that during rotation of the cylindrical rotor about the rotational axis alternately fluidly communicate with at least one channel of the plurality of channels; and
a second end cover having a second surface that interfaces with and slidingly and sealingly engages the second end face, wherein the second end cover has at least one second fluid inlet and at least one second fluid outlet that during rotation of the cylindrical rotor about the rotational axis alternately fluidly communicate with at least one channel of the plurality of channels; and
wherein the cylindrical rotor has a first longitudinal length in an axial direction and the cylindrical rotor comprises at least one groove disposed along the first longitudinal length, and the at least one groove extends in a circumferential direction about the cylindrical rotor.

16. The rotary IPX of claim 15, comprising a sleeve, wherein the cylindrical rotor is disposed within the sleeve in a concentric arrangement.

17. The rotary IPX of claim 16, wherein the sleeve has a second longitudinal length and comprises an opening along the second longitudinal length.

18. The rotary IPX of claim 17, wherein the opening is disposed at a first axial midpoint of the sleeve, and the opening is centered relative to a second axial midpoint of the at least one groove.

19. The rotary IPX of claim 17, wherein the opening is disposed at a first axial midpoint of the sleeve, and the opening is off-centered relative to a second axial midpoint of the at least one groove.

20. A system, comprising:
a rotary isobaric pressure exchanger (IPX), comprising:
a sleeve having a first longitudinal length in an axial direction, wherein the sleeve comprises an opening along the second longitudinal length; and
a rotor having a first longitudinal length in the axial direction disposed within the sleeve in a concentric arrangement, wherein the rotor comprises at least one groove disposed along the first longitudinal length, and the at least one groove extends in a circumferential direction about the rotor; and
wherein the at least one groove has a groove length in the axial direction that is at least half of the first longitudinal length of the rotor.
